(19) United States
(12) Patent Application Publication
(10) Pub. No.: US 2020/0189683 A1
(43) Pub. Date: Jun. 18, 2020

(54) PORTABLE DOCKING SYSTEM AND PORTABLE DOCKING STATION

(71) Applicant: CRETRONIX, Inc., Mission Viejo, CA (US)

(72) Inventor: Yin Hua Chen, Mission Viejo, CA (US)

(21) Appl. No.: 16/224,493

(22) Filed: Dec. 18, 2018

(51) Int. Cl. B62K 15/00; B62H 5/00; B62K 3/00; G06Q 30/06

(52) U.S. Cl. CPC B62K 15/006; B62H 5/005; B62K 3/002; B62H 2003/005; B60L 2200/24; B60L 2270/36; B60Y 2200/126; G06Q 30/0645

(57) ABSTRACT

The portable docking station comprises a movable system and at least one set of holders. The movable system comprises a central supporter; a first lateral supporter; a second lateral supporter; a first upper rack movably coupled to the central supporter and rotatably coupled to the first lateral supporter; a second upper rack movably coupled to the central supporter and rotatably coupled to the second lateral supporter; a first lower rack rotatably coupled to the central supporter and movably coupled to the first lateral supporter; and a second lower rack rotatably coupled to the central supporter and movably coupled to the second lateral supporter. Each of the set of holders comprises an upper holder coupled to the first upper rack; and a lower holder coupled to the first lower rack. A portable docking system of using the aforementioned portable docking station is also disclosed.

### TECHNICAL FIELD OF THE INVENTION

The present application generally relates to a docking system, and more particularly, to a portable docking system and a portable docking station which are capable of charging at least one vehicle.

### BACKGROUND OF THE INVENTION

Currently, there are companies that introduced vehicle-leasing services to consumers in most of the populated cities. However, the companies were not aware of the potential problems it would create from the vehicle-leasing services. A scooter-leasing service is a good example for the above situation.

From the perspective of providers, the companies allow renters to return the leased scooters in a wide area in the city. Problem is raised where scooters are piled up such as in pedestrian sidewalks, streets or lawns. It is annoying for the residents and even becomes public hazard. Even worse, it may also trigger anger for the residents to vandalize scooters or throw the scooters away such as in the lake or other public areas. Companies end up with a pile of damaged scooters.

Moreover, it is required for the companies to collect the stranded scooters and charge them overnight. The companies may miss some leasing opportunities because the low battery scooters cannot be rented until they are charged.

From the perspective of renters, the renters have no clue to know which scooter is in good condition beforehand until they arrive the leasing location. In addition, although a fully-charged scooter may run about 20 to 30 miles, the renter may have no idea thus leave the scooter at random locations in the city when battery runs out since the docking station is hard to find in some places such as suburbs or remote areas.

Therefore, a need remains for a portable docking system and a portable docking station to provide an improved rental quality for both vehicle providers and renters.

### SUMMARY OF THE INVENTION

The present application discloses a portable docking system and a portable docking station to provide an improved rental quality for both vehicle providers and renters.

The portable docking station comprises a movable system and at least one set of holders. The movable system comprises a central supporter; a first lateral supporter; a second lateral supporter; a first upper rack movably coupled to the central supporter and rotatably coupled to the first lateral supporter; a second upper rack movably coupled to the central supporter and rotatably coupled to the second lateral supporter; a first lower rack rotatably coupled to the central supporter and movably coupled to the first lateral supporter; and a second lower rack rotatably coupled to the central supporter and movably coupled to the second lateral supporter. Each of the set of holders comprises an upper holder coupled to the first upper rack; and a lower holder coupled to the first lower rack.

In various exemplary embodiments, the portable docking station further comprises a charger coupled to the first lateral supporter. The charger may be a swappable power bank.

In various exemplary embodiments, the upper holder comprises a body coupled to the first upper rack and comprising an accommodation space; and a plate located partially within the accommodation space, wherein the plate comprises charging connectors. Specifically, the charging connectors are located at a bottom surface of the plate.

In various exemplary embodiments, the upper holder comprises a body coupled to the first upper rack and comprising an accommodation space; and a plate located partially within the accommodation space, wherein the plate comprises diagnostic connectors. Specifically, the diagnostic connectors are located at a bottom surface of the plate.

In various exemplary embodiments, the upper holder comprises a body coupled to the first upper rack and comprising an accommodation space; a plate located partially within the accommodation space; and a handle coupled to the plate.

In various exemplary embodiments, the lower holder comprises a first plate coupled to the first lower rack; and a second plate coupled to the second lower rack.

In various exemplary embodiments, the first lateral supporter comprises a first upper rod; a first middle rod coupled to the first upper rod; a first lower rod coupled to the first middle rod; a first upper connecting rod coupled to the first upper rod, wherein the first upper rack is hinged to the first upper connecting rod. The second lateral supporter comprises a second upper rod; a second middle rod coupled to the second upper rod; a second lower rod coupled to the second middle rod; and a second upper connecting rod coupled to the second upper rod, wherein the second upper rack is hinged to the second upper connecting rod. According to an exemplary embodiment of the portable docking station, the first lateral supporter further comprises a first lower connecting rod coupled to the first middle rod, the first middle rod comprises a first rail, the first lower rack comprises a first roller coupled to the first rail; wherein the second lateral supporter further comprises a second lower connecting rod coupled to the second middle rod, the second middle rod comprises a second rail, the second lower rack comprises a second roller coupled to the second rail.

In various exemplary embodiments, the central supporter comprises a set of fixtures; and a moving board coupled to the first upper rack and the second upper rack, wherein the moving board is removably coupled to the set of fixtures.

In various exemplary embodiments, the central supporter comprises a fixture coupled to the first lower rack and the second lower rack. The fixture comprises a first set of slots and a second set of slots, the first, lower rack comprises a first rod passed through the first set of slots, the second lower rack comprises a second rod passed through the second set of slots.

In various exemplary embodiments, the portable docking station further comprises at least one first wheel coupled to the first lateral supporter; and at least one second wheel coupled to the second lateral supporter.

In various exemplary embodiments, the upper holder comprises a groove. The groove is located at a bottom surface of the upper holder.

The portable docking system comprising a portable docking station and a foldable vehicle. The portable docking station comprises a movable system and at least one set of holders. The moving system comprises a central supporter; a first lateral supporter; a second lateral supporter; a first upper rack movably coupled to the central supporter and rotatably coupled to the first lateral supporter; a second upper rack movably coupled to the central supporter and rotatably coupled to the second lateral supporter; a first lower rack rotatably coupled to the central supporter and movably coupled to the first lateral supporter; and a second lower rack rotatably coupled to the central supporter and movably coupled to the second lateral supporter. Each of the set of holders comprises an upper holder coupled to the first upper rack; and a lower holder coupled to the first lower rack. The foldable vehicle is removably coupled to one of the at least one set of holders.

In various exemplary embodiments, the foldable vehicle comprises a stand; a handle coupled to the stand; a bottom fixture removably coupled to the lower holder; and a bearing board coupled to the bottom fixture and comprising a first board and a second board, wherein the first board is rotatably coupled to the second board via a shaft pivot. According to an exemplary embodiment of the portable docking system, the upper holder comprises a body coupled to the first upper rack and comprising an accommodation space; and a plate located partially within the accommodation space, wherein the plate comprises docking charging connectors and docking diagnostic connectors. The foldable vehicle further comprises a vehicle charging connectors; and a vehicle diagnostic connectors, wherein the vehicle charging connectors are coupled to the docking charging connectors and the vehicle diagnostic connectors are coupled to the docking diagnostic connectors while the foldable vehicle is coupled to the portable docking station.

Based on the above, the present application allows the vehicle providers to deploy the docking stations at any location without a need of infrastructure and technician due to foldable and portable structure of the docking station. In addition, since the portable docking station comprises scalable built-in charger, the docking station can charge multiple scooters at the same time in any locations. Meanwhile, since the portable docking station of the present application comprises diagnostic connectors, the scooter may also be diagnosed simultaneously.

Numerous other advantages and features of the present application will become readily apparent from the following detailed description of disclosed embodiments, from the claims and from the accompanying drawings.

### BRIEF DESCRIPTION OF THE DRAWINGS

The objects, features and advantages of the present application will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIGS. 1-3 show a portable docking station of the present application.

FIG. 4 shows an upper rack and multiple upper holders of the portable docking station.

FIGS. 5-6 show the upper holder of the portable docking station.

FIG. 7 shows a mechanism of engaging a foldable vehicle and the portable docking station.

FIG. 8 shows a portable docking system of the present application.

### DETAILED DESCRIPTION OF DISCLOSED EMBODIMENTS

Reference will now be made in detail to the present representative embodiments of the present application, examples of which are illustrated in the accompanying drawings. Wherever possible, the same reference numbers are used in the drawings and the description to refer to the same or like parts.

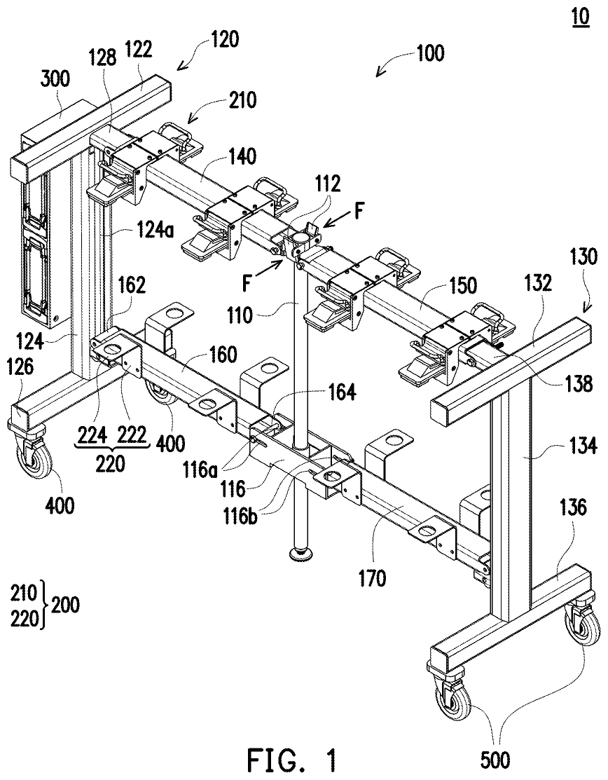

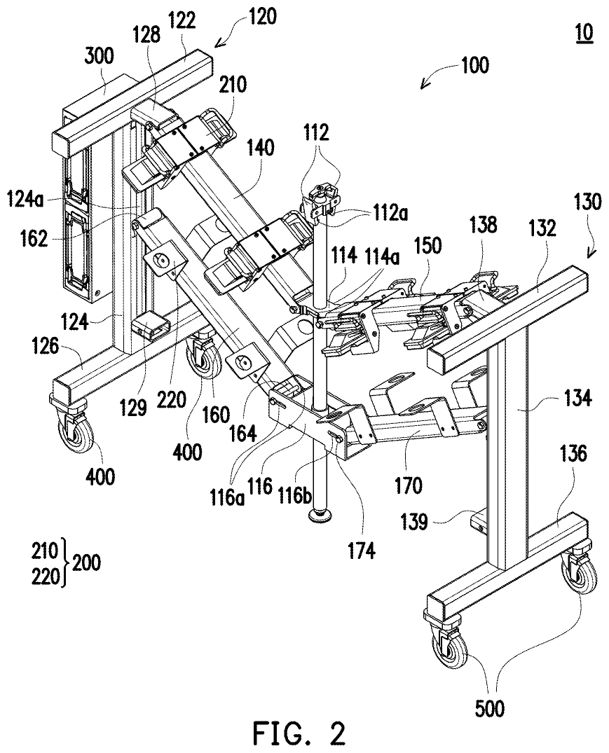

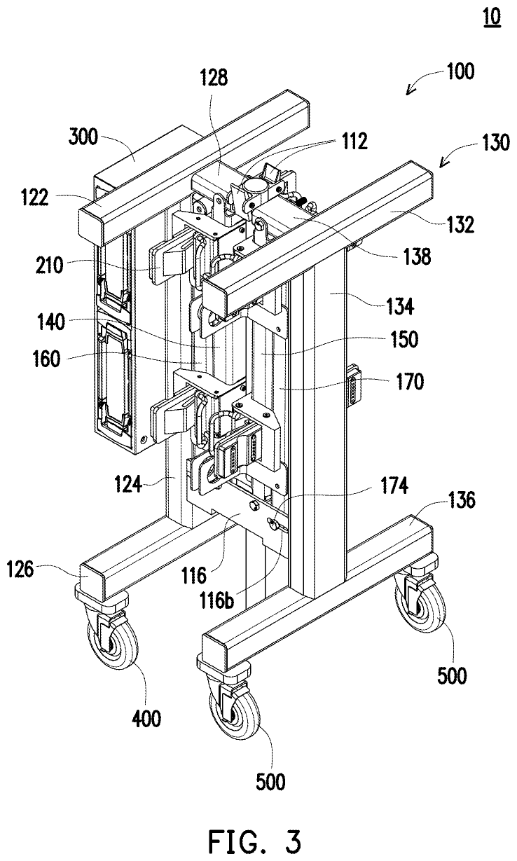

FIGS. 1-3 show a portable docking station 10 of the present application.

Referring to FIGS. 1-3, the portable docking station 10 of the present application comprises a movable system 100, at least one set of holders 200, a charger 300, wheels 400 and wheels 500.

The movable system 100 comprises a central supporter 110, a lateral supporter 120, a lateral supporter 130, an upper rack 140, an upper rack 150, a lower rack 160 and a lower rack 170.

The central supporter 110 comprises a set of fixtures 112, a moving board 114 and a fixture 116. Specifically, the set of fixtures 112 is coupled at the top of the central supporter 110. The moving board 114 is removably coupled to the set of fixtures 112. The fixture 116 is coupled at the bottom of the central supporter 110.

Each of the fixtures 112 comprises an edge 112a which is capable of locking the moving board 114 at the top of the central supporter 110. The edges 112a may release the moving board 114 after pressing the set of the fixtures 112 in a direction toward the central supporter 110 as arrows F shown in FIG. 1.

The moving board 114 comprises a hole and recesses 114a. The central supporter 110 is passed through the hole. The recesses 114a is capable of being engaged with the edges 112a, providing a stronger engagement. However, the present application is not limited, the moving board 114 may be designed with or without the recesses 114a. In addition, the shapes of the edges 112a and the recesses 114a may be modified as long as the fixtures 112 can lock and release the moving board 114, the present application is not limited either.

The fixture 116 comprises a hole, a set of slots 116a and a set of slots 116b. The central supporter 110 is passed through the hole. The details of the set of slots 116a and the set of slots 116b will be described with the lower rack 160 and the lower rack 170.

The lateral supporter 120 comprises an upper rod 122, a middle rod 124, a lower rod 126, an upper connecting rod 128 and a lower connecting rod 129.

The middle rod 124 is coupled to upper rod 122 and comprises a rail 124a. The lower rod 126 is coupled to the middle rod 124. The upper connecting rod 128 is coupled to the upper rod 122. The lower connecting rod 129 is coupled to the lower rod 126.

Simply put, the upper rod 122, the middle rod 124 and the lower rod 126 constitute an I-shaped structure. However, the present application is no limited, the shape of the combination of the upper rod 122, the middle rod 124 and lower rod 126 can be modified as long as the lateral supporter 120 can support the upper rack 140, the upper rack 150, the lower rack 160 and the lower rack 170 with the central supporter 110 and the lateral supporter 130.

The lateral supporter 130 and the lateral supporter 120 have the same structure. The lateral supporter 130 comprises an upper rod 132, a middle rod 134, a lower rod 136, an upper connecting rod 138 and a lower connecting rod 139.

The middle rod 134 is coupled to upper rod 132 and comprises a rail (not separately illustrated). The lower rod 136 is coupled to the middle rod 134. The upper connecting rod 138 is coupled to the upper rod 132. The lower connecting rod 139 is coupled to the lower rod 136.

Simply put, the upper rod 132, the middle rod 134 and the lower rod 136 constitute an I-shaped structure. However, the present application is no limited, the shape of the combination of the upper rod 132, the middle rod 134 and lower rod 136 can be modified as long as the lateral supporter 130 can support the upper rack 140, the upper rack 150, the lower rack 160 and the lower rack 170 with the central supporter 110 and the lateral supporter 130.

It should be noted that the lateral supporter 130 may have different structures from the lateral supporter 120, the present application is not limited thereto.

The upper rack 140 is movably coupled to the central supporter 110. Specifically, one end of the upper rack 140 is hingedly coupled to the moving board 114. Therefore, the upper rack 140 is capable of moving along the central supporter 110 with the moving board 114. Another end of the upper rack 140 is hingedly coupled to the lateral supporter 120, allowing the upper rack 140 to rotate around the lateral supporter 120. Specifically, the upper rack 140 is coupled to the upper connecting rod 128. However, the present application is not limited thereto, the upper rack 140 can be coupled to anywhere of the lateral supporter 120 as long as the upper rack 140 can be rotated around the lateral supporter 120 while the end coupled to the central supporter 110 is moved along the central supporter 110.

The upper rack 150 and the upper rack 140 have the same structure. The only difference is that the upper rack 150 is coupled to the lateral supporter 130 rather than lateral supporter 120.

The lower rack 160 is movably coupled to the lateral supporter 20. Specifically, the lower rack 160 comprises a roller 162 coupled at one end of the lower rack 160. The roller 162 is capable of rolling along the rail 124a. The lower connecting rod 129 is capable of stopping the roller 162 at the bottom of the middle rod 124. The lower rack 162 further comprises a rod 164 coupled at another end of the lower rack 160. The rod 164 is passed through the set of slots 116a, working as a hinge which is capable of allowing the lower rack 160 to rotate around the central supporter 110. It should be noted that the present application is not limited thereto, the lower rack 160 can be coupled to the central supporter 110 by other kinds of joints such as ball-and-socket joint or pivot joints as long as the lower rack 160 can be rotated around the central supporter 110 while the end coupled to the lateral supporter 120 is moved along the lateral supporter 120.

The lower rack 170 and the lower rack 160 have the same structure. The only difference is that the lower rack 170 is coupled to the lateral supporter 130 rather than lateral supporter 120.

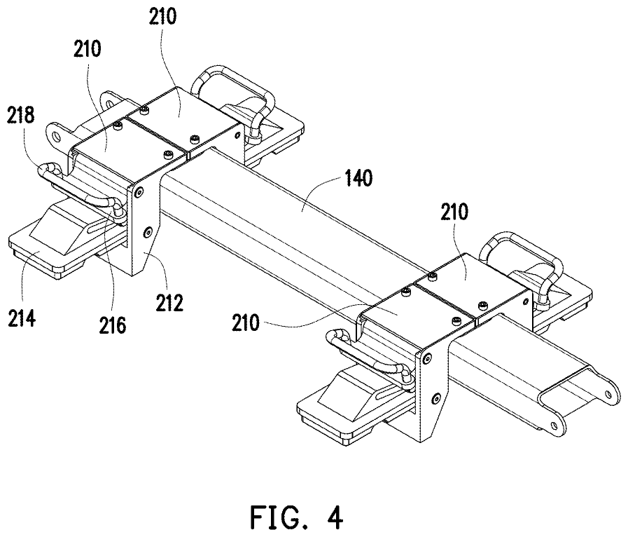

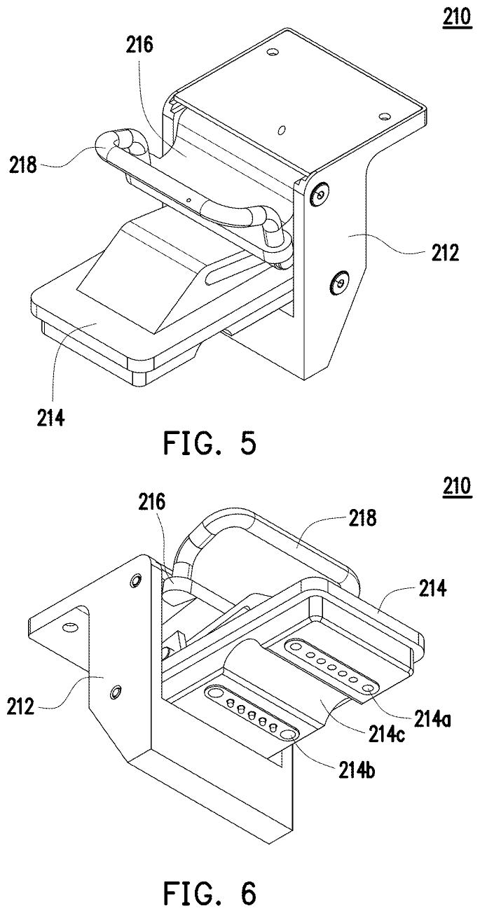

FIG. 4 shows an upper rack 140 and multiple upper holders 210 of the portable docking station 10. FIGS. 5-6 show the upper holder 210 of the portable docking station 10.

The portable docking station 10 comprises at least one set of holders 200. Specifically, referring to FIG. 1, FIG. 1 shows 8 set of holders 200 installed on the portable docking station 10. However, the present application is not limited. The number of the set of holders 200 may be adjusted along with the length of the upper rack 140, the upper rack 150, the lower rack 160 and/or the lower rack 170.

Referring to FIG. 1 and FIGS. 4-6, one set of holders 200 comprises the upper holder 210 and a lower holder 220.

The upper holder 210 comprises a body 212, a plate 214, a plate 216 and a handle 218. The body 212 is coupled to the upper rack 140 via screws. However, the present application is not limited. The body 212 may be coupled to the upper rack 140 via other methods such as mortise and tenon joint. The body 212 comprises an accommodation space.

The plate 214 is partially located within the accommodation space and is capable of being rotated around the body 212. The plate 214 comprises charging connectors 214a, diagnostic connectors 214b and a groove 214c. Specifically, the charging connectors 214a the diagnostic connectors 214b and the groove 214c are located at a bottom surface of the plate 214. The plate 216 is partially located within the accommodation space and is capable of being rotated around the body 212. The handle 218 is coupled to the plate 218.

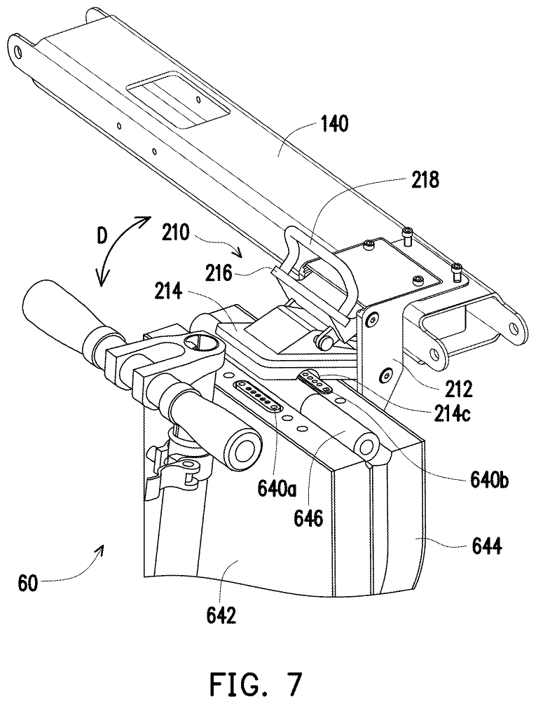

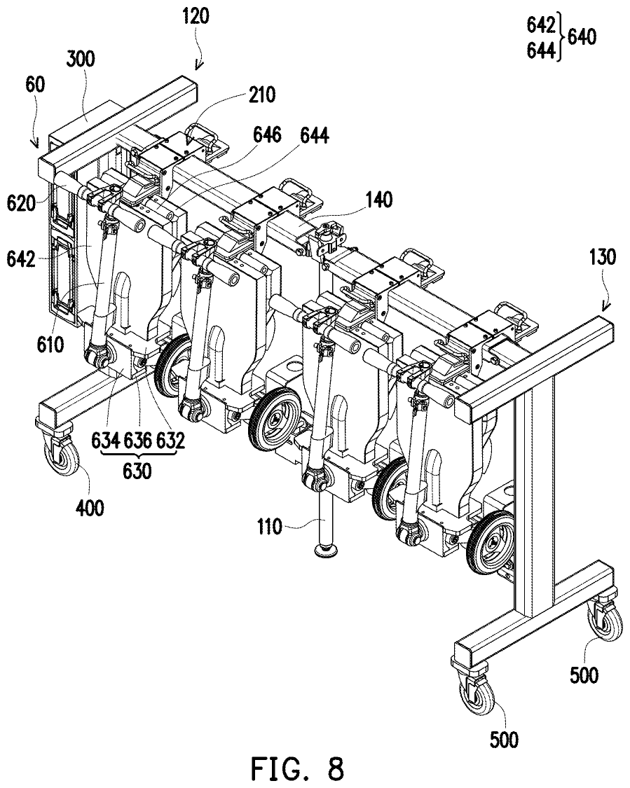

The lower holder 220 comprises a plate 222 and a plate 224. The plate 222 is coupled to the lower rack 160. The plate 224 is coupled to the plate 222 and comprises a hole in order to cope with hot-expansion and cold-shrinkage. The plate 222 and the plate 224 constitute a L-shaped structure. However, the present application is not limited. The plate 222 and the plate 224 can constitute different shape as long as a vehicle 60 (referring to FIGS. 7-8) can be docked.

FIG. 7 shows a mechanism of engaging the foldable vehicle 60 and the portable docking station 10. FIG. 8 shows a portable docking system of the present application.

Referring to FIGS. 7-8, the charger 300 is coupled to the lateral supporter 120. However, the charger 300 is removable and may be located anywhere as long as the charger 300 can provide electricity when charging and diagnosing. Specifically, the charger 300 is a swappable power bank. In addition, the present application only illustrates two batteries as an example. However, the number of the battery is not limited thereto.

The portable docking station 10 further comprises wheels 400 and wheels 500. The wheels 400 are coupled to the lateral supporter 120. The wheels 500 are coupled to the lateral supporter 130. It should be noted that although there are two wheels 400 and two wheels 500 shown in the present application, the present application is not limited thereto. The portable docking station 10 may comprise only one wheel 400 and one wheel 500 or more than two wheels 400 and more than two wheels 500.

As shown in FIGS. 7-8, the foldable vehicle 60 may be docked in the portable docking station 10 of the present application. Specifically, the vehicle 60 of the present application comprises a stand 610, a handle 620, a bottom fixture 630 and a bearing board 640.

The handle 620 is coupled to the stand 610. The bottom fixture 630 is coupled to the stand 610. The bottom fixture 630 comprises a plate 632, a plate 634 coupled to the plate 632, and a plate 636 coupled to the plate 634. Specifically, the combination of the plate 632, the plate 634 and the plate 636 constitute a U-shaped structure. The plate 224 (referring to FIG. 1) of the lower holder 220 (referring to FIG. 1) is capable of being inserted into the bottom fixture 630 when coupling the vehicle 60 to the portable docking station 10.

The bearing board 640 is coupled to the bottom fixture 630. The bearing board 640 comprises a board 642, a board 644 and a shaft pivot 646. The board 642 is rotatably coupled to the board 644 via the shaft pivot 646. The bearing board 640 further comprises charging connectors 640a and diagnostic connectors 640b. Specifically, the charging connectors 640a are located at a side surface of the board 642 and the diagnostic connectors 640b are located at a side surface of the board 644.

Referring to FIGS. 7-8, the upper holder 210 may be lifted up and down along the arrow D, allowing the vehicle 60 to be docked in the portable docking station 10. Specifically, the charging connectors 640a of the vehicle 60 are coupled to the charging connectors 214a (referring to FIG. 6) of the portable docking station 10; the diagnostic connectors 640b of the vehicle 60 are coupled to the diagnostic connectors 214b (referring to FIG. 6) of the portable docking station 10; and the pivot shaft 646 is coupled to the groove 214c of the portable docking station 10. Specifically, the charging connectors 640a, charging connectors 214a, diagnostic connectors 640b and diagnostic connectors 214b are pogo pin connectors, allowing vehicles 60 to be charged without plugging in cable from AC power.

Regarding charging, the vehicle 60 may be charged from the charger 300 by connecting the charging connectors 640a of the vehicle 60 and the charging connectors 214a (referring to FIG. 6) of the portable docking station 10. If the vehicle 60 has not been charged well, the portable docking station 10 may automatically lock the vehicle 60 to prevent renters from renting it. In addition, charging status of each vehicle 60 may be reported back to cloud where the central control is located for the vehicle providers to provide a real-time information.

Similarly, if the portable docking station 10 detects a problem with the vehicle 60, the portable docking station 10 may automatically lock the vehicle 60 to prevent renters from renting it. In addition, the diagnostic result may be reported back to cloud for the vehicle providers to determine its subsequent processing.

Based on the above, the present application allows the vehicle providers to deploy the docking stations at any location without a need of infrastructure and technician due to foldable and portable structure of the docking station. Specifically, since the portable docking station can be packed into a small package, it is compact and light enough for the vehicle providers to set it up and move its locations.

In addition, since the portable docking station comprises scalable and removable charger, the docking station can charge multiple scooters at the same time in any locations. Meanwhile, since the portable docking station of the present application comprises diagnostic connectors, the scooter may also be diagnosed simultaneously, preventing the renters from renting a flawed vehicle.

It will be apparent to those skilled in the art that various modifications and variations can be made to the structure of the present application without departing from the scope or spirit of the present application. In view of the foregoing, it is intended that the present application cover modifications and variations of this application provided they fall within the scope of the following claims and their equivalents.

What is claimed is:

1. A portable docking station comprising:
a movable system comprising:
a central supporter;
a first lateral supporter;
a second lateral supporter;
a first upper rack movably coupled to the central supporter and rotatably coupled to the first lateral supporter;
a second upper rack movably coupled to the central supporter and rotatably coupled to the second lateral supporter;
a first lower rack rotatably coupled to the central supporter and movably coupled to the first lateral supporter; and
a second lower rack rotatably coupled to the central supporter and movably coupled to the second lateral supporter; and
at least one set of holders, each of the set of holders comprises:
an upper holder coupled to the first upper rack; and
a lower holder coupled to the first lower rack.

2. The portable docking station as claimed in claim 1, further comprises a charger coupled to the first lateral supporter.

3. The portable docking station as claimed in claim 2, wherein the charger is a swappable power bank.

4. The portable docking station as claimed in claim 1, wherein the upper holder comprises:
a body coupled to the first upper rack and comprising an accommodation space; and
a plate located partially within the accommodation space, wherein the plate comprises charging connectors.

5. The portable docking station as claimed in claim 4, wherein the charging connectors are located at a bottom surface of the plate.

6. The portable docking station as claimed in claim 1, wherein the upper holder comprises:
a body coupled to the first upper rack and comprising an accommodation space; and
a plate located partially within the accommodation space, wherein the plate comprises diagnostic connectors.

7. The portable docking station as claimed in claim 6, wherein the diagnostic connectors are located at a bottom surface of the plate.

8. The portable docking station as claimed in claim 1, wherein the upper holder comprises:
a body coupled to the first upper rack and comprising an accommodation space;
a plate located partially within the accommodation space; and
a handle coupled to the plate.

9. The portable docking station as claimed in claim 1, wherein the lower holder comprises:
a first plate coupled to the first lower rack; and
a second plate coupled to the second lower rack.

10. The portable docking station as claimed in claim 1,
wherein the first lateral supporter comprises:
a first upper rod;
a first middle rod coupled to the first upper rod;
a first lower rod coupled to the first middle rod; and
a first upper connecting rod coupled to the first upper rod, wherein the first upper rack is hinged to the first upper connecting rod;
wherein the second lateral supporter comprises:
a second upper rod;
a second middle rod coupled to the second upper rod;
a second lower rod coupled to the second middle rod; and
a second upper connecting rod coupled to the second upper rod, wherein the second upper rack is hinged to the second upper connecting rod.

11. The portable docking station as claimed in claim 10, wherein the first lateral supporter further comprises a first lower connecting rod coupled to the first middle rod, the first middle rod comprises a first rail, the first lower rack comprises a first roller coupled to the first rail; wherein the second lateral supporter further comprises a second lower connecting rod coupled to the second middle rod, the second middle rod comprises a second rail, the second lower rack comprises a second roller coupled to the second rail.

12. The portable docking station as claimed in claim 1, wherein the central supporter comprises:
a set of fixtures; and
a moving board coupled to the first upper rack and the second upper rack, wherein the moving board is removably coupled to the set of fixtures.

13. The portable docking station as claimed in claim 1, wherein the central supporter comprises a fixture coupled to the first lower rack and the second lower rack.

14. The portable docking station as claimed in claim 13, wherein the fixture comprises a first set of slots and a second set of slots, the first lower rack comprises a first rod passed through the first set of slots, the second lower rack comprises a second rod passed through the second set of slots.

15. The portable docking station as claimed in claim 1, further comprising:
at least one first wheel coupled to the first lateral supporter; and
at least one second wheel coupled to the second lateral supporter.

16. The portable docking station as claimed in claim 1, wherein the upper holder comprises a groove.

17. The portable docking station as claimed in claim 16, wherein the groove is located at a bottom surface of the upper holder.

18. A portable docking system comprising:
a portable docking station comprising
a movable system comprising:
a central supporter;
a first lateral supporter;
a second lateral supporter;
a first upper rack movably coupled to the central supporter and rotatably coupled to the first lateral supporter;
a second upper rack movably coupled to the central supporter and rotatably coupled to the second lateral supporter;
a first lower rack rotatably coupled to the central supporter and movably coupled to the first lateral supporter; and
a second lower rack rotatably coupled to the central supporter and movably coupled to the second lateral supporter; and
at least one set of holders, each of the set of holders comprises:
an upper holder coupled to the first upper rack; and
a lower holder coupled to the first lower rack; and
a foldable vehicle removably coupled to one of the at least one set of holders.

19. The portable docking station as claimed in claim 18, wherein the foldable vehicle comprises:
a stand;
a handle coupled to the stand;
a bottom fixture removably coupled to the lower holder; and
a bearing board coupled to the bottom fixture and comprising a first board and a second board,
wherein the first board is rotatably coupled to the second board via a shaft pivot.

20. The portable docking station as claimed in claim 19, wherein the upper holder comprises:
a body coupled to the first upper rack and comprising an accommodation space; and
a plate located partially within the accommodation space, wherein the plate comprises docking charging connectors and docking diagnostic connectors,
wherein the foldable vehicle further comprises:
a vehicle charging connectors; and
a vehicle diagnostic connectors, wherein the vehicle charging connectors are coupled to the docking charging connectors and the vehicle diagnostic connectors are coupled to the docking diagnostic connectors while the foldable vehicle is coupled to the portable docking station.
